(19) United States
(12) Patent Application Publication
(10) Pub. No.: US 2020/0179959 A1
(43) Pub. Date: Jun. 11, 2020

(54) LIQUID JET SHAPER AND SPRAY SHAPER

(71) Applicant: SMIXIN SA, Bienne (CH)

(72) Inventor: Vincent Vaucher, Sonceboz-Sombeval (CH)

(21) Appl. No.: 16/640,160

(22) PCT Filed: Aug. 21, 2018
(86) PCT No.: PCT/EP2018/072591

§ 371 Date: Feb. 19, 2020

(30) Foreign Application Priority Data
Aug. 21, 2017 (EP) 17187134.6

(51) Int. Cl. B05B 1/34; B05B 1/18

(52) U.S. Cl. CPC B05B 1/3421; E03C 1/084; B05B 1/185

(57) ABSTRACT

A jet shaper for shaping, from a liquid, a jet consisting of multiple subjets of the liquid, and to a spray shaper and an associated method. The jet shaper includes a spray former and a spray distributor. The spray former is arranged to generate from the liquid a spray of the liquid in a shape of a spray cone under ambient conditions. The spray distributor is arranged to shape, from the spray of the liquid, the jet of the liquid, wherein the jet of the liquid consists of multiple subjets of the liquid being free of mutual overlap. The spray former includes a spray former outlet and a flight chamber. The flight chamber is arranged to allow droplets of the spray to follow a flight path from the spray former outlet in an essentially straight line towards the spray distributor.

A first aspect of the invention relates to the field of jet shapers for liquids. It relates to a liquid jet shaper as described in the preamble of the corresponding independent claims. Liquid jet shapers are for example faucet aerators (also called tap aerators) or shower heads, where the liquid jet shaper shapes a jet of liquid from a liquid entering the liquid jet shaper. In other words: a liquid jet shaper forms a liquid into a liquid jet which features a spatial distribution different from the liquid entering the liquid jet shaper.

A second aspect of the invention relates to the field of spray shapers.

A liquid jet shaper can for example be used for hand washing and for personal hygiene using a jet of liquid (especially water or water-based liquids like a soap solution) in general. A liquid jet shaper can for example be used for cleaning of an object like dishes and/or food (vegetables, fruit), and/or any other application where a faucet in a sanitary installation is used.

One aspect of known liquid jet shapers is that they form liquid jets to save liquid. In many cases, the liquid is water, and jet shapers are used to reduce water consumption and/or spillage.

In order to save liquid, liquid entering a known liquid jet shaper (in short: the jet shaper) is handled in a manner inside the jet shaper that the exiting jet of the liquid features a flow, consistency and/or energy different from of the liquid entering the jet shaper. The jet of liquid exits the jet shaper in a form which allows to use the jet of liquid for the same applications like a liquid not having passed the jet shaper. But a flux of liquid through the jet shaper is smaller than a flux of liquid not having passed the jet shaper, and therefore liquid is saved.

Known jet shapers for example add air to the liquid and thereby create foam. The jet of liquid exiting the jet shaper therefore comprises foam. Other known jet shapers simply divide the liquid entering the jet shaper into a multitude of small streams of liquid (like in a simple shower head or a watering can with a multitude of exit holes).

Although liquid can be saved with the known jet shapers in comparison with not using a known jet shaper, the know jet shapers have different disadvantages. One disadvantage is that the jet of liquid exiting the jet shape features a low energy. This is for example the case with foam or trickling streams of liquid. The jet of liquid with low energy is not suitable for cleaning purposes, where high energy jets of liquids are more effective. In order to increase the energy, known jet shapers have to increase a flow of liquid and hence have to reduce the effect of saving liquid.

Known jet shaper generate a jet of liquid whose haptic is unfavorable. Either the jet of liquid is too soft (like in many cases for a foam or for a multitude of trickling small streams). Or the jet of liquid is too hard, too tingly and/or too stingy (like for example a multitude of very small streams with high exiting velocity). If an unfavorable aspect of the haptic is reduced (for example through less air in the foam, more flow divided in small streams and/or increased size of small streams), then again the effect of saving liquid by the known jet shapers is reduced.

Known jet shaper can feature a complicated design. For a high effect of saving liquid, the shaper is constructed in a complicated manner. In order to be able to provide a high level of energy in the jet of liquid and/or to provide a jet of liquid with good haptic all the while featuring a good effect of saving liquid, known jet shaper can feature a multitude of elements, chambers, treating steps and stages, energy sources, control/measure/steering elements and many more components. Jet shaper with complicated designs and constructions are fragile, prone to malfunctioning, prone to clogging, complicated to repair and/or to clean, expensive in production, large in size and/or heavy.

Some known jet shapers need external energy to function properly, for example in form of electricity. Such jet shapers are difficult to install, to maintain and to repair.

Furthermore, electricity can be dangerous regarding the use of the jet shaper itself (for example through an isolation failure) and/or be dangerous in combination with liquids entering and/or exiting the jet shaper.

It is therefore an object of the first aspect of the invention to create a jet shaper of the type mentioned initially, which overcomes at least partially at least one of the disadvantages mentioned above.

This object is achieved by a jet shaper according to claim 1 and a method to shape a jet according to claim 15.

The inventive jet shaper according to the first aspect of the invention, for shaping from a liquid a jet consisting of multiple subjets of the liquid, comprises a spray former and a spray distributor. The spray former is arranged to generate from the liquid a spray of the liquid in a shape of a spray cone under ambient condition. And the spray distributor is arranged to shape from the spray of the liquid the jet of the liquid. The jet of the liquid consists of multiple subjets of the liquid, and the multiple subjets of the liquid are free of mutual overlap. The spray former comprises a spray former outlet and a flight chamber. The spray former outlet is arranged as an exit point for the spray being generated. And the flight chamber is arranged to allow droplets of the spray to follow a flight path from the spray former outlet in an essentially straight line towards the spray distributor.

A spray is a multitude of droplets of a liquid which are separated by gas.

In other words, a spray is a liquid dispersed in gas. A spray is a multitude of individual droplets dispersed in a gas medium. For example, droplets of water in air is a spray. The droplets of liquid in a spray feature a mass large enough to allow for the small droplet to keep its own momentum.

If the droplets of liquid are too small for spray, these droplets are suspended in the gas surrounding them, resulting in mist instead of spray. A spray is therefore different from mist.

A spray is also different from foam. A foam is a gas phase dispersed in a liquid phase, i.e. gas bubbles in a liquid medium. In contrast to this, spray is droplets of liquid in a gas medium.

A typical size of droplets of liquid in a spray is a diameter of 500 micrometers or smaller, but larger as 200 micrometers.

Ambient condition means conditions in a normal environment for an average human being. Ambient condition means therefore at ambient pressure and temperatures in a range of 1 degree Celsius to 55 degrees Celsius. The generation of the spray of the liquid under ambient condition is independent of a temperature of the liquid. The temperature of the liquid can be in the range of 1 degree Celsius to 55 degrees Celsius. The temperature of the liquid can be lower than 1 degree Celsius. The temperature of the liquid can be higher than 55 degrees Celsius.

The spray former is arranged to generate a spray of the liquid from the liquid passing the spray former. The spray of the liquid exiting the spray former features the shape of a spray cone. The spray of the liquid exits the spray former into a space under ambient condition. Therefore, the spray cone is generated under ambient condition.

The spray former is arranged to generate a spray of spray droplets. A spray is a multitude of spray droplets of the liquid which are dispersed in gas. These spray droplets (in short: droplets) span up the spray cone by all their flight paths. The flight path of the droplets in the spray cone are essentially straight. The inside of the spray cone is free of mist and backflow. The spray cone is free from an accumulation of spray i.e. free from a jam of droplets as all droplets follow their essentially straight flight path from a spray former outlet away. The droplets do not cross each other inside the spray cone.

If the flight path is “essentially” a straight flight path, the flight path is meant to be “essentially in straight direction”. The expression “essentially” means in this text if related to a direction that a deviation of 45 degrees or less from the direction is “essentially in the direction”. Optionally, a deviation of 30 degrees or less from the direction means “essentially in the direction”. Or for example a deviation of 15 degrees or less from the direction means “essentially in the direction”.

The essentially straight flight path of droplets means that the flow of a spray comprising these droplets is laminar.

In contrast to laminar flow of a spray comprising droplets following essentially straight flight paths, a flow of a spray can be turbulent when the droplets comprised in this spray follow irregular i.e. erratic paths.

The spray distributor is arranged to shape the jet of the liquid (in short: jet) from the spray of the liquid (in short: spray). To shape means to form, i.e. to change the spatial configuration. The spray distributor guides, deflects and/or distributes the spray into the shape of the jet. The jet consists of multiple subjets of the liquid (in short: subjets). The multiple subjets are free of mutual overlap which means that the subjects do not touch or merge mutually. The multiple subjets exit the jet shaper into air in an environment which is under ambient condition.

The spray distributor is arranged to shape the spray to the multiple subjets, which means collecting the droplets of the spray to the subjets. The spray distributor is arranged to influence the flight path of the droplets in order to form the subjets while influencing the speed and energy of the droplets only to an extent needed to shape the jet. In other words, the spray distributor is arranged to keep the speed and energy of the spray droplets as much as possible while shaping the subjets. A reduction of speed and/or energy of the spray droplet for other reasons than for shaping the subjets is unforeseen in the spray distributor.

With respect to energy, the jet shaper is arranged to essentially function as described in the following paragraphs (minor side effects which do not contribute essentially to the processes are not mentioned): the liquid entering features potential energy and possibly a minor kinetic component from a flow inside a supply channel of the liquid in direction of the jet shaper. Moreover, the liquid in the supply channel of the liquid is under pressure (at least under pressure caused by its own weight, i.e. liquid column pressure/water column pressure). The spray former generates the spray, and the spray droplets in the spray cone feature a high kinetic energy compared to the liquid entering the spray former. This high kinetic energy of the droplet originates from the pressure and the potential energy of the liquid in the supply channel. Also the energy to overcome a surface tension of the liquid in order to generate the droplets from the liquid i.e. in order to create the spray originates from the pressure and the potential energy of the liquid in the supply channel. The spray distributor shapes the subjets from the spray by deviating the droplets only as much as needed, and thus reduces the speed and energy of the droplets by the deviation into the subjets (the deviation causes energy loss due to friction of the droplets, i.e. due to heat).

Inside the jet which is exiting the jet shaper (i.e. inside the subjets exiting the jet shaper), the droplets are free of an exertion of pressure on the droplet (except from the atmospheric pressure of the environment) and follow their flight path with the speed and the energy provided by the jet shaper and the potential energy of the droplet. The droplets in the subjets are on the one hand slowed down through friction with the air in the environment (air resistance, aerodynamics). On the other hand, the droplets in the subjets are accelerated in gravitational direction and gain speed due to their potential energy (the droplet is falling in the air).

When the subjets hit an object (which, depending on the application of the jet shaper, can for example be a body part or an object to be washed—like a hand, vegetable or a dish), the kinetic energy of the droplets is transformed into pressure on the object and heat (through friction) while a rest of kinetic energy results in the droplets to move away from an impact location on the object (flowing away, splashing, reflected or deviated droplets flying away in a different direction).

The inventive jet shaper generates a jet (i.e. multiple subjets) of droplets, which allows to save a lot of liquid compared to known jet shapers or no use of any jet shaper. The generation of a jet with the inventive jet shaper is efficient in liquid consumption. In other words: the inventive jet shaper features a low consumption.

The jet generated by the jet shaper features droplets of size and the speed in a predefined range. Due to a specific construction of the jet shaper and due to provision of the liquid under predefined conditions (pressure, temperature, flow etc.), size and speed of the droplets of the generated spray lie in a predefined range. Thus, significant discrepancies in size and/or speed of the droplets can be minimised or avoided. As an advantageous consequence, waste of water and/or energy is minimised or avoided (droplets too small and/or too slow i.e. outside the predefined range are wasted because the lack of the desired effects). Furthermore, negative effects can be minimised or avoided (droplets too large and/or too fast i.e. outside the predefined range can for example feel uncomfortable or even can hurt). Moreover, droplets too small lose their heat very quickly (several cm in free flight) in case of heated water, which can be avoided through the generation of droplets of size and speed in the predefined range. Optionally, the generated droplets of the spray feature essentially the same size and the same speed.

The subjets hitting an object feature a predefined amount of speed and mass sufficient for the desired applications (like for example cleaning purposes) while at the same time being produced by the jet shaper with a low flow of liquid i.e. while saving a lot of liquid. The energy of the droplets is high and can be used in the desired application, therefore a high flow of liquid and/or high velocity of liquid can be avoided.

The subjets feature a specified direction and/or shape due to the spray distributor. The generated jet therefore features a predefined spatial configuration of the subjets which is chosen specifically for an application. By way of this, the liquid can be used efficiently. Waste of liquid and/or energy is minimized or eliminated. The subjets can be arranged to aim at a specific impact area in a specific spatial configuration of the subjets.

While featuring a low consumption, the jet shaper at the same time provides a jet with a favorable haptic. While hitting an object, the droplets in the subjets exert a pressure on the object which is in the desired and predefined range (higher than too soft but lower than being too hard, too tingly and/or too stingy). When hitting human body parts, the subjets generate a good and satisfying feeling of a liquid flow. The subjets give a sensation of abundance and weight on skin. The liquid jet exiting the jet shaper is experienced as soft, full, pleasant and rich flow of liquid while being a specifically shaped jet of collected spray droplets.

The jet shaper generates the spray and the subjets under environmental conditions. The pressure in the spray cone and after the spray distributor is neither substantially elevated nor substantially reduced, which renders the jet shaper a safe device. The jet shaper functions without an external energy, only with energy provided by the liquid entering the jet shaper (potential energy and pressure). The jet shaper is safe and functions independent from external energy sources.

The jet shaper features a simple construction. The jet shaper can be assembled from only a few parts. The production of the jet shaper therefore is cheap and simple. Installation, maintenance and repair of the jet shaper are easy, efficient and cost effective. The jet shaper functions reliably. The simple design prevents clogging of the jet shaper. The jet shaper is compact in size and lightweight.

The jet shaper comprises a spray former as well as a spray distributor. Only a spray former alone just generates a spray which either does not produce enough pressure on an object hit by this spray or does not allow to save liquid when delivering enough spray which is at the same time fast enough to provide enough pressure on an object hit by this spray. A spray former alone generates a spray expanding spatially in usually not well defined directions. And only a distributor alone shapes foam or a liquid flow, so again liquid saving is not very efficient. A combination of the spray former with the spray distributor further downstream features the advantages describe above. The spray former and the spray distributor function together in a symbiotic way. In combination, the spray former and the spray distributor allow to build a very efficient jet shaper.

As an optional feature, the subjets of the jet shaper are free of mutual overlap at least for a distance of 30 centimeters downstream of the spray distributor. The subjets of the jet shaper are for example free of mutual overlap at least for a distance of 100 centimeters downstream of the spray distributor. The subjets of the jet shaper can be free of mutual overlap at least for a distance of 200 centimeters downstream of the spray distributor.

The liquid is for example water. The liquid is in another example a solution based on water. The liquid can be an emulsion containing water.

Optionally, the jet shaper is used exclusively in sanitary fitting. Especially in faucets, for example in faucets for hand washing.

The jet shaper can be used for different applications. Applications for the jet shaper can be for example hand washing, hair care, personal hygiene, food (vegetables/fruits) cleaning, dish cleaning and/or cleaning respectively washing of other objects.

Further embodiments are evident from the dependent patent claims. Features of the device claims may be combined with features of the method claims and vice versa.

As an optional feature, an opening angle of the spray cone lies in a range beginning with 20 degrees and ending with 160 degrees.

A rotation axis of the cone, which means an axis with regard to a rotation symmetry of the spray cone, is called cone axis. The opening angle of the spray cone is twice as large as an angle enclosed between the cone axis of the cone and an outer surface of the cone. The opening angle of the spray cone for example lies in a range beginning with 50 degrees and ending with 140 degrees. The opening angle of the spray cone can lie in a range beginning with 80 degrees and ending with 120 degrees.

In other words, the opening angle is the aperture of the spray cone.

The spray cone in the jet shaper is a three dimensional real word object and as such not a pure geometrical cone with a single geometrical point at its tip. In strict geometrical wording, the spray cone might be described as a truncated cone. The opening angle of the spray cone can be regarded as the aperture of the geometrical shape of a truncated cone, which sometimes is also called a frustum of a cone.

Optionally, the spray former is arranged for generating a spray equally distributed in the spray cone.

In other words: the whole spray cone is filled with spray. Such a spray cone is called full spray cone. The full spray cone is not hollow and does not feature a spray in a form like a curtain or a blade inside the cone. The full spray cone allows to produce a spray with many droplets from the liquid inside cone.

In another embodiment, the spray cone is hollow.

Hollow spray cone means that the spray cone features a volume inside the spray cone which is free of spray droplets.

A hollow spray cone features a distribution of droplets in a region close to an outer surface of the spray cone. The hollow spray cone allows to concentrate the spray droplets in the region of the outer surface of the spray cone.

Optionally, the spray former comprises at least one guiding element for the liquid inducing a rotational movement of the liquid around one swirling axis of the spray former. The rotational movement generates a spray wherein the cone axis of the spray cone is parallel to the swirling axis of the spray former.

The at least one guiding element is a stationary element in the spray former. The guiding element functions in a passive manner and is free of a drive. In other words: the guiding element functions by guiding, channeling and/or deflecting the liquid, not by actively moving the liquid.

The rotational movements generates the spray in a way which can be described as cyclone effect (or as using a centrifugal nozzle). At least a part of the rotational energy of the liquid is used to separate the droplets from the liquid—these droplets then form the spray. The liquid therefore loses energy when creating the spray, because at least some of the rotational energy is used to overcome the surface tension. Due to the rotational energy i.e. the rotational movement, the droplets are formed and fly away from the liquid in a flight path. These droplets then create the spray cone.

In other words: droplets are detached from the rotating fluid, and these droplets—once detached from the rotating fluid—follow their flight paths independently from the fluid. The flight paths of these droplets follow an essentially straight line.

Alternatively, the spray former is arranged to generate the spray in a pressure sprayer (without rotational movement of the fluid, just a nozzle and pressure).

Optionally, the number n of subjets of the liquid is equal or an integer multiple of the number m of guiding elements for the liquid. Expressed as a formula: n=x*m where x is an integer number greater or equal to 1.

This means that the ratio of the number n of subjets in the spray distributor to the number m of guiding elements in the spray former is an integer. In other words, it is mathematically possible to assign an integer number x of subjets to each guiding element.

Optionally, x is an integer in the range from and with 1 to and with 5.

For example, x is an integer in the range from and with 1 to and with 3. The integer x can also be 1.

The advantage of such an integer ratio is a homogenous distribution of the spray especially with regard to the subjets. This means that although the spray distribution may not perfect due to a limited number of guiding elements (where each guiding element by definition induces a movement and therefore can cause local inhomogeneities), the possible inhomogeneities caused by the guiding elements can be arranged in an advantageous manner relative to the subjets. In other words: possible density fluctuations caused by multiple guiding elements—especially if the guiding elements are arranged symmetrically—can feature a symmetric spatial distribution. This symmetric spatial distribution can be matched and/or assigned to a symmetric pattern of subjets in case of the integer ratio mentioned above.

As an optional feature, the number m of guiding elements lies in a range beginning with 2 and ending with 20.

The number m of guiding elements can lie for example in a range beginning with 4 and ending with 16. The number m of guiding elements lies for example in a range beginning with 6 and ending with 12.

As an optional feature, the guiding element for the liquid comprises a liquid passage for inducing the rotational movement of the liquid which is passing through the liquid passage, with the rotational movement of the liquid being around the swirling axis. The liquid passage is arranged in form of a circumferentially enclosed opening in the spray former, the opening extending with a component along the swirling axis as well as a component around the swirling axis.

The liquid passage is circumferentially enclosed and therefore forms a laterally closed channel or in other words a structure like a hose, tube, closed duct and/or pipe.

The liquid passage can comprise one opening per end, i.e. one entry for the liquid and one exit for the liquid. The liquid passage can feature multiple ends, for example two entries merging to one exit and therefore feature an essentially Y-shaped shape.

The shape of the cross section of the liquid passage can for example be circular, square, rectangular, trapezoidal, curved or irregular. The shape and/or size of the cross section of the liquid passage can vary along the extension of the liquid passage. An area of the cross section of the liquid passage can gradually decrease further downstream the liquid passage. The shape and/or size of the cross section of the liquid passage can for example stay constant along the extension of the liquid passage.

The component “around the swirling axis” can be a component leading to a circular pathway around the swirling axis (in such a case, it would be a component tangential to the circular pathway around the swirling axis). The component “around the swirling axis” can for example also be a component leading to a pathway around the swirling axis in form of a widening or narrowing spiral. A pathway in form of a narrowing spiral thereby extends at least 180 degrees around the swirling axis, which means at least halfway around the swirling axis.

Due to a combination of the component along the swirling axis and the component around the swirling axis, the liquid passage extends essentially in a helicoidal manner around the swirling axis.

As an optional feature, all liquid passing the spray former passes the spray former through at least one liquid passage.

Alternatively, the spray former can comprise guiding elements in form of protrusions and/or recesses. Also a combination of at least one liquid passage and at least one other form of a guiding element is possible.

The spray former can contain one guiding element. Also two guiding elements are possible. The spray former contains for example three guiding elements. The spray former can contain four guiding elements. Also five or more guiding elements can be in the spray former.

Optionally, all guiding elements in the spray former feature the same shape. The guiding elements can feature shapes different from each other in another example.

As another optional feature, the swirling axis of the spray former is coincident with the cone axis of the spray cone. A swirling axis coincident with the cone axis allows a compact design of the spray former.

Alternatively, the swirling axis is offset relative to the cone axis. Such a design allows to induce a movement of the fluid along an eccentric path (eccentric with regard to the spray cone).

The spray former comprises a spray former outlet and a flight chamber. The spray former outlet is arranged as an exit point for the spray being generated. And the flight chamber is arranged to allow droplets of the spray to follow a flight path from the spray former outlet in an essentially straight line towards the spray distributor.

The spray former outlet can also be called nozzle. The spray former outlet is therefore arranged on top of the spray cone or in other words is situated at the head of the spray cone. The spray former outlet is for example arranged in a rotation symmetrical manner around the cone axis.

The flight chamber allows the droplets to fly towards the spray distributor in an undisturbed manner which results in an essentially straight line for the flight path of the droplet. This means that the droplets are free of contact with walls of the flight chamber. In other words, the droplets are not reflected or deviated by the flight chamber walls. The droplets can follow their flight path from the spray former outlet in direction of the spray distributor inside the flight chamber. The flight path of the droplet through the flight chamber is therefore direct. In a same cross section plane through the flight chamber, a cross section of the flight chamber is at least of the same size as a cross section of the spray cone.

An “essentially” straight line is defined analogue to the essentially straight flight path (see above).

The flight chamber is a three dimensional space between the spray former outlet and the spray distributor. The flight chamber encloses the spray cone.

In other words: the flight chamber starts at the spray former outlet (the smaller end i.e. the tip of the spray cone) and ends at the spray distributor (the wider end of the spray cone). The flight chamber surrounds the spray cone. The flight chamber is a room which allows the spray droplet follow its path from the spray former outlet to the spray distributor, inside the spray cone.

The flight chamber can be formed inside a confined space such as a flight chamber housing. The flight chamber can be formed inside a partially confined space such as a flight chamber housing with one or more openings.

An advantage of the flight chamber allowing the droplet to fly in an undisturbed manner is that no droplets are retained. This means that the flight chamber remains essentially free of retained or reflected liquid in any form (foam, liquid layer, mist). Therefore, droplet following their flight path in the spray cone are not hindered on the way through the flight chamber and therefore can keep as much as possible of their energy.

The flight chamber protects the spray from the environment. The spray is for example protected from drying since the flight chamber is able to restrict contact of the spray with (dry) air. Drying of the spray droplets can thus be reduced or eliminated by the flight chamber. Less or no drying spray results in less or no residues from the liquid, as for example less or no limestone which could be deposited in the jet shaper as a residue from water. As a consequence, the jet shaper can work efficiently. The jet shaper can be maintenance friendly. The jet shaper can be constructed free of margins needed for potential residues in order to prevent partial or full blockage i.e. clogging of parts of the jet shaper. By way of this, passages in the jet shaper for liquid (as a flow, spray and/or droplets) can be realized in small absolute size with only a small risk of clogging.

The flight chamber features for example a conical shape. The flight chamber can feature a frustro-conical shape.

Optionally, in orthogonal projection on the swirling axis of the spray former, the most distant point of the least one guiding element is maximally 5 millimeters away from the most distant point of the spray former outlet.

In other words, the spray former is compact in a dimension along the swirling axis. The distance (along the swirling axis) from the beginning of the at least one guiding element to the spray former outlet is smaller or equal to 5 millimeters. Expressed differently, the height of the spray former part from the first point of the highest guiding element down to the spray former outlet is 5 millimeters. The part of the spray former from a beginning of the guiding elements to the spray former outlet is 5 millimeters high.

In particular, in orthogonal projection on the swirling axis of the spray former, the most distant point of the least one guiding element is maximally 4 millimeters away from the spray former outlet. In particular, in orthogonal projection on the swirling axis of the spray former, the most distant point of the least one guiding element is maximally 3 millimeters away from the spray former outlet.

The advantage of such a compact arrangement is a reduction of size of the whole jet shaper. Such a compact jet shaper allows to integrate this first aspect of the invention with its advantages (as for example liquid i.e. water saving) in existing constructions and/or to apply it to environments with restricted or limited space.

A compact dimension has also the advantage of low liquid consumption. The device is filled with only a small volume of liquid, and therefore the device is quickly filled and is operational in a short amount of time. Due to the compact dimension, the pressure drop in the liquid is low.

Optionally, the number m of guiding elements is inversely proportional to the height of the spray former part from the first point of the highest guiding element down to the spray former outlet.

For example, a multiplication of this height in millimeters times the number m of guiding elements always results in 20 millimeters. This means that for a height of 20 millimeters, one guiding element is used. For a height of 10 millimeters, two guiding elements are used. And so forth.

The more compact the dimension of the spray former is, the more guiding elements are used in order to provide an even spray distribution in the spray cone.

Optionally, a maximal cross section of the flight chamber in any plane perpendicular to the cone axis can for example be comprised in an area between a circle around the cone axis with a diameter of 30 millimeters and a circle around the cone axis with a diameter of 5 millimeters. The maximal cross section means the largest i.e. broadest or most extended part of the spray cone.

As a further optional feature, the spray former outlet features a circular opening with a diameter which lies in a range beginning with 0.3 millimeters and ending with 5 millimeters.

In case the spray former outlet features an opening in a shape different from a circular opening, an area of a cross section of the spray former outlet equivalent to an area of a circle with the diameter given in this text is meant. This means for example a circular opening with a diameter of 5 millimeters means an area of roughly 19.6 square millimeters.

A spray former outlet with a circular opening with a diameter of 0.3 millimeters features an area large enough in order to prevent clogging of the spray former outlet.

The diameter of the spray former outlet can for example lie in a range beginning with 0.5 millimeters and ending with 3 millimeters. In another example, the diameter of the spray former outlet lies in a range beginning with 1 millimeter and ending with 2 millimeters.

The spray former outlet is arranged in size and shape for producing droplets large and fast enough to fly in a straight line through air. In other words, droplets generated by the spray former are too large to form mist, and they are large enough to be free of substantial reflection or deflection due to air—the droplets are slowed down by the air resistance, but do not substantially change their flight path due to air they are flying through.

However, it is possible that during spray production a low number of droplets small enough to form mist are produced by the spray former outlet. A production of such small droplets is preferably circumvented, but can happen to a small extent as a side product of the spray production.

For example, a droplet small enough to form mist is a droplet with a diameter of 200 micrometers or less. Especially, a droplet small enough to form mist is a droplet with a diameter of 140 micrometers or less. A droplet small enough to form mist can be a droplet with a diameter of 60 micrometers or less.

The droplets small enough to form mist comprise for example 5% or less of the total liquid flow through the spray former outlet. Especially, the droplets small enough to form mist comprise 3% or less of the total liquid flow through the spray former outlet. Optionally, the droplets small enough to form mist comprise 1% or less of the total liquid flow through the spray former outlet.

If a bit of mist is produced by the spray former outlet, the flight chamber will help to guide the mist to the jet distributor. The mist is concentrated into heavier droplets in the flight chamber and/or by the spray distributor and added to the subjets. These small droplets which able to form mist are in contrast to the other droplets of the spray able to be reflected and/or deviated in the flight chamber, for example by the flight chamber wall.

Optionally, the jet shaper is arranged such that the spray former outlet features a circular spray former outlet with a diameter, measured in millimeters, which stands in relation to a liquid flow through the jet shaper, measured in liters per minute, in a range of a ratio of liquid flow divided by spray former outlet diameter beginning with 0.1 and ending with 2.

The ratio mentioned above can for example lie in a range beginning with 0.15 and ending with 1.5. The ratio can for example lie in a range beginning with 0.2 and ending with 1. It is possible that for one embodiment this ratio lies in a range beginning with 0.22 and ending with 0.8.

As already mentioned further above and also applicable to the ratio defined above: in case the spray former outlet features an opening in a shape different from a circular opening, an area of a cross section of the spray former outlet equivalent to an area of a circle with the diameter given in this text is meant.

As an optional feature, the number n of subjets lies in a range beginning with 2 subjets and ending with 20 subjets.

The number n of subjets can lie for example in a range beginning with 4 subjets and ending with 16 subjets. The number n of subjets lies for example in a range beginning with 6 subjets and ending with 12 subjets.

A subjet duct exit is an opening at a downstream end of a subjet duct (in short: duct) in the spray distributor. One subjet exits the spray distributor at each duct exit. The number of duct exits in the spray distributor is therefore equal to the number n of subjets generated by the jet shaper.

The duct in the spray distributor is an opening in the spray distributor arranged to allow spray droplets to pass the spray distributor and to exit the spray distributor in a subjet. The duct functions as a deflector and channels the droplets into subjets.

If the duct exit features a form different from a circular shape, the equivalent area of the circular shaped duct exit as described in the paragraph above is applicable to the non-circular shaped duct exit. This is analogue to the size limitation description of the spray former outlet.

Optionally, the jet shaper is arranged such that a spray distributor outlet total surface (i.e. a sum of all subjet duct exit areas), measured in square millimeters, which stands in relation to a liquid flow through the jet shaper, measured in liters per minute, in a range of a ratio of liquid flow divided by spray former outlet total surface beginning with 0.03 and ending with 0.12.

The ratio mentioned above can for example lie in a range beginning with 0.034 and ending with 0.08. The ratio can for example lie in a range beginning with 0.035 and ending with 0.05.

Regarding size, shape, number and spatial arrangement, features described for the duct of the spray distributor can be applied (where applicable) to the liquid passage of the spray former and vice versa. The duct can differ in size and shape from the liquid passage.

The duct is for example arranged in form of a circumferentially enclosed opening in the spray distributor, the opening extending with only with a component along the cone axis. Such a duct can extend free of a component around the cone axis.

As an optional feature, subjets exit the spray distributor at subjet duct exits which are all arranged in only one linear line or in only one substantially round line on the spray distributor.

A substantially round line means for example an ellipsoidal line, a circular line, a kidney shaped line or a pear shaped line. A continuous line with for example less radial deviation than 30 percent from a circle is substantially round.

The substantially round line is for example positioned symmetrically with regard to a rotation around the cone axis.

The substantially round line of the subjet duct exits is for example arranged in the region of an outer surface of the spray cone. In combination with the hollow spray cone as described above, the spray former can provide droplets mainly in a region where they can be redirected by the spray distributor without big changes in flight speed and flight direction into the subjets.

Alternatively, the duct exits are arranged in a regular two-dimensional lattice i.e. grid. For example a grid with square cells, or a grid with hexagonal cells.

The duct exits can be arranged in an irregular manner at the spray distributor.

The spray distributor can feature a region at and close to the cone axis which is free of a duct exit. In this case, the spray distributor optionally features a central deflector guiding the spray droplets away from the cone axis. The spray distributor can also be free of a central deflector.

As another example, the spray distributor can feature a duct exit within the region at and close to the cone axis.

The duct can feature a conical shape, with its large cross section positioned upstream and its small cross section positioned downstream.

As an optional feature, the spray former comprises an air inlet.

The air inlet in the spray former allows air to enter the flight chamber. By way of this, air can be added to the spray i.e. to a stream of flying spray droplets. The air inlet is for example positioned between the spray former outlet and the spray distributor. Optionally, the air inlet is positioned at the flying chamber in a region close to the spray former outlet. The air inlet can for example be positioned in the spray former upstream of the spray former outlet. Alternatively, air can access the flight chamber by ways around the spray former.

The air in the flight chamber fills the space between the spray droplets. In other words, the spray is enriched with air.

The air inlet can comprise one or more openings in an enclosure of the flight chamber.

The air added to the flight chamber through the air inlet can help the spray to flow in a laminar manner. The air inlet can help to reduce or to eliminate turbulences in the spray cone. The air added to the flight chamber through the air inlet can move along the flying spray droplets, preventing air pressure differences in the spray cone which could deviate the flying spray droplets.

As an optional feature, the jet shaper is arranged to withstand only a pressure of the liquid entering the jet shaper of equal to or less than 10 bar, or the jet shaper comprises a pressure limiter arranged upstream of the spray former relative to a direction of flow of the liquid in order to limit a pressure of the liquid entering the jet shaper to equal to or less than 10 bar.

The maximal pressure the jet shaper is arranged to withstand is for example 3 bar. Or the maximal pressure the jet shaper is arranged to withstand is for example 1.5 bar.

This means that the jet shaper is foreseen to function at a pressure of maximally 10 bar (or 3 bar or 1.5 bar respectively). The jet shaper is therefore designed for relatively low pressure applications. Since the jet shaper does not have to withstand pressures higher than the maximal pressure, the jet shaper material and construction is chosen specifically for this pressure range. At low pressure, stress on material is relatively small and therefore a use of cost effective material and design is possible.

The pressure limiter limits the pressure of the liquid up to or to less than to the pressure the jet shaper is arranged to withstand maximally.

Optionally, the pressure limiter is arranged to provide a constant liquid flow in the designated pressure range. The pressure limiter then also acts as a flow limiter.

The pressure limiter is then arranged to provide the constant liquid flow independently of the pressure of the liquid acting on the pressure limiter from an upstream side.

Pressure limiter can limit liquid pressure and optionally also liquid flow. Therefore, the pressure limiter allows to use the jet shaper independently from boundary conditions like liquid pressure and optionally liquid flow. For example, when using the jet shaper in faucets in buildings, the liquid pressure and liquid flow can vary from building to building as well as within a building itself (for example between floors on different heights etc.). With such a pressure limiter, the same jet shaper without any modification can be used in different environments, in buildings and for different applications.

Alternatively, the jet shaper can be used free of a pressure limiter. The jet shaper can for example be arranged to withstand liquid pressures of higher than 1.5 bar.

In particular, the jet shaper is functional at low pressures. For example, the jet shaper is functional with pressures in a range of 0.2 to 1 bar (as an input pressure to the jet shaper).

Optionally, the jet shaper is arranged for a liquid flow through the jet shaper equal to or less than 2 liters per minute.

The liquid flow through the jet shaper can be equal to or less than 1 liter per minute. The liquid flow through the jet shaper is especially equal to or less than 0.55 liters per minute.

The jet shaper being arranged for a specific maximum of a liquid flow means that the jet shaper features spatial constraints (for example size and/or shape of the spray former outlet and/or the subjet ducts) specifically chosen for this specific maximum of the liquid flow. Liquid flows above the specific maximum can block and/or flood the jet shaper.

The advantages of a jet shaper arranged for a maximal liquid flow as described above are for example analogue to the ones described above for a jet shaper withstanding only a specific liquid pressure.

As an optional feature, the jet shaper comprises a droplet size limiter positioned downstream the spray former, the droplet size limiter being arranged to allow passage of the spray droplets free of a backflow.

The droplet size limiter can for example be arranged as a grid or mesh with openings of predefined size and/or shape. The droplet size limiter is arranged to reduce a size of the droplets in case the droplets are too large. The droplet size limiter is arranged to control the maximum size of droplets in the spray. While droplets being small enough essentially keep their direction and speed of flight, droplets being too large keep their direction of flight but are slowed down due to the droplets being reduced in size. In other words, the spray droplet flight direction is essentially kept for all droplets, but small droplets pass the droplet size limiter at their speed of flight and too large droplets are reduced to small droplets before exiting the droplet size limiter.

The maximum size of droplets after a passage through the droplet size limiter is for example a diameter of 400 micrometers. The maximum size of droplets after the passage through the droplet size limiter can be a diameter of 300 micrometers. The maximum size of droplets after the passage through the droplet size limiter can be a diameter of 250 micrometers.

The droplet size limiter is arranged to prevent backflow of droplets or liquid. In other words, an accumulation of droplets or liquid upstream the droplet size limiter is avoided due to a droplet size limiter design.

In one embodiment, the droplet size limiter comprises a mesh made of thin wires.

Optionally, a thickness of the droplet size limiter is equal to or smaller than 1 millimeter. Especially, the thickness of the droplet size limiter is equal to or smaller than 0.5 millimeters. The thickness of the droplet size limiter can for example be equal to or smaller than 0.3 millimeters. The thickness of the droplet size limiter is a distance a droplet has to pass between entering and exiting the droplet size limiter if the droplet is able to pass the droplet size limiter essentially keeping its direction and its speed of flight.

The jet shaper can be free of a droplet size limiter.

As an optional feature, the jet shaper is arranged for a liquid entry direction of the liquid entering the jet shaper being substantially parallel to a direction of the subjets exiting the jet shaper i.e. to a subjet exit direction.

Such an arrangement of liquid entry direction and subjet exiting direction is advantageous because the force of gravity can be used efficiently.

The liquid entry direction can for example be perpendicular to the cone axis. The liquid entry direction is for example inclined with respect to the cone axis in an angle between 20 and 70 degrees.

As an optional feature, the jet shaper is mounted in an installation and is arranged for the subjets exiting the jet shaper to follow a trajectory through air essentially along the direction of gravity.

The trajectory of the subjets exiting the jet shaper can for example be inclined with respect to the direction of gravity.

Optionally, the subjet trajectory is essentially parallel to the cone axis.

As an optional feature, a subjets exiting the jet shaper follows a trajectory essentially along one direction from the jet shaper to at least up to 100 centimeters downstream of the jet shaper.

Optionally, all subjets exiting the jet shaper follow essentially parallel trajectories.

The inventive method for shaping from a liquid a jet of the liquid according to the first aspect of the invention comprises
a) generating a spray cone of the liquid from the liquid, the liquid droplets inside the spray cone following an essentially straight flight path in the spray cone, and
b) shaping the jet of the liquid from the spray cone of the liquid at an end of the spray cone, the jet of the liquid consisting of multiple subjets of the liquid being free of mutual overlap.

The second aspect of the invention relates to the field of spray shapers. Spray shapers are devices producing spray from a liquid.

Known spray shapers use pressure, heat, electric energy, static energy and/or kinetic energy to produce spray from the liquid. These known spray shapers use a large amount of energy in order to work properly. Therefore, they do not work properly under all conditions. In some known spray shapers, the use of energy causes a large drop of pressure in the spray shaper itself. In certain known spray shapers, a high flow of liquid is required for proper spray production. Especially in environments with limited resources and/or limited energy sources, known spray shapers do work insufficiently or even not at all. Known spray shapers cannot all work properly in ambient condition.

Known spray shapers can be large devices. The production of the spray occurs in spatially extended devices. Therefore, known spray shapers cannot be included in environments and/or devices with limited space. Known spray shapers are difficult to integrate in compact devices.

In known spray shapers, the produced spray might be heterogeneously distributed. This can be caused by design, lack of energy and/or lack of space. Any of this causes can lead to inhomogeneities in the produced spray and/or make a known spray shaper work incorrectly.

It is therefore an object of the second aspect of the invention to create a spray shaper of the type mentioned initially, which overcomes at least partially at least one of the disadvantages mentioned above.

This object is achieved by a spray shaper according to the second aspect of the invention.

A spray shaper according to the second aspect of the invention for shaping from a liquid a spray cone under ambient condition comprises a spray shaper body, a spray shaper outlet on the spray shaper body and fixed on the spray shaper body at least one guiding element for the liquid inducing a rotational movement of the liquid around one swirling axis of the spray shaper and with an inclination angle of 30 degrees or less relative to a plane perpendicular to the swirling axis of the spray shaper, the rotational movement of the liquid generating a spray cone exiting the spray shaper through the spray shaper outlet wherein a cone axis of the spray cone is parallel to the swirling axis of the spray shaper.

The inclination angle of the rotational movement of the liquid relative to a plane perpendicular to the swirling axis of the spray shaper means the angle of a liquid stream in the rotational movement (i.e. the liquid particle path) leaving the guiding element on its way to the spray shaper outlet.

The inclination angle of the rotational movement of the liquid relative to a plane perpendicular to the swirling axis of the spray shaper can be 20 degrees or less. In particular, the inclination angle of the rotational movement of the liquid relative to a plane perpendicular to the swirling axis of the spray shaper is 10 degrees.

Spray shapers as a part of the jet shaper are described further above in the description of the jet shaper. More precisely, spray shapers in the jet shapers are a part of the spray former. The spray former of the jet shaper described above comprises a spray shaper and a flight chamber. In other words, the spray former described above without flight chamber can be regarded as a device comprising a spray shaper or even as being a spray shaper. Therefore, some elements in the spray shaper are designated as spray shaper parts and in the spray former as spray former parts, although they are the same elements. For example, the spray shaper outlet in the spray shaper is called spray former outlet in the spray former.

The inventive method for shaping from a liquid a spray of the liquid under ambient conditions according to the second aspect of the invention comprises
a) inducing a rotational movement of the liquid around one swirling axis of the spray shaper and with an inclination angle of 30 degrees or less relative to the swirling axis of the spray shaper, and
b) the rotational movement of the liquid generating a spray cone wherein a cone axis of the spray cone is parallel to the swirling axis of the spray shaper.

All definitions described above for the first aspect of the invention (the jet shaper) also apply in analogue manner to the second aspect of the invention (the spray shaper).

All features and advantages of elements of the jet shaper described above (under the first aspect of the invention) apply to the analogue elements and method steps of the spray shaper (the second aspect of the invention).

As already written above, features of the device claims may be combined with features of the method claims and vice versa. Corresponding advantages apply for the device as well as for the method.

The subject matter of the invention will be explained in more detail in the following text with reference to exemplary embodiments which are illustrated in the attached drawings, in which:

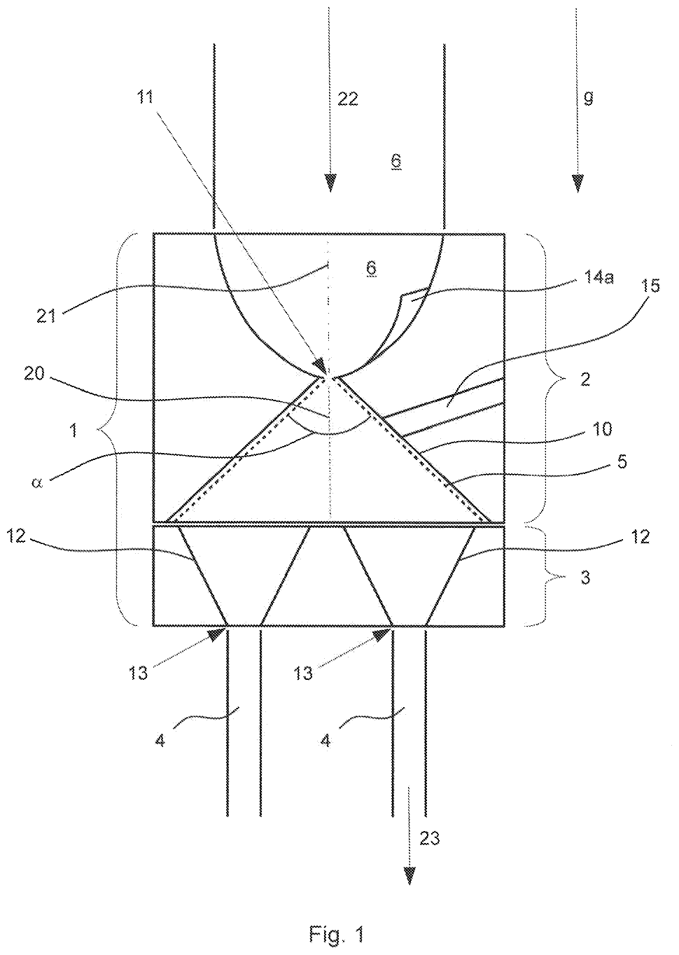

FIG. 1 shows a principle sketch of a cut through a jet shaper in side view;

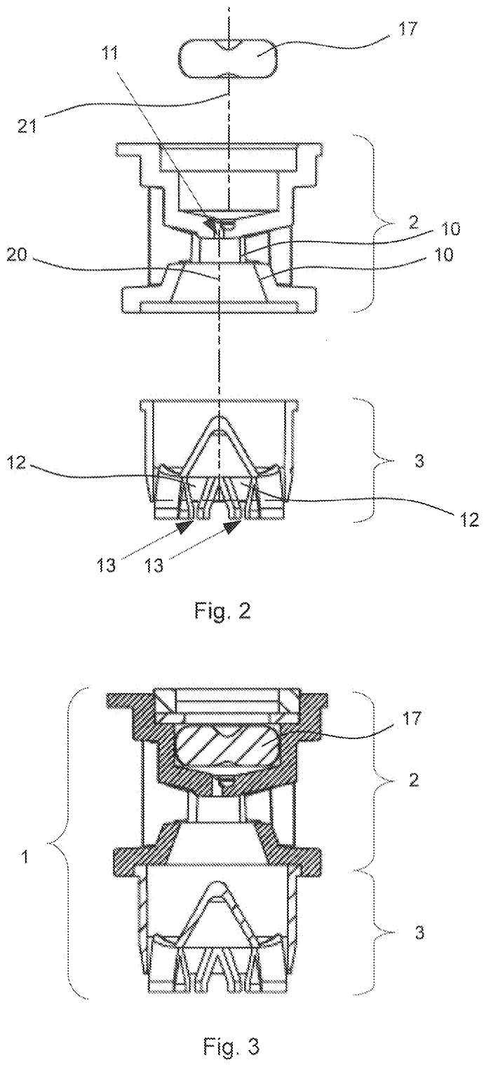

FIG. 2 schematically shows components of a first embodiment of a jet shaper in side view;

FIG. 3 schematically shows the jet shaper of FIG. 2 in an assembled state;

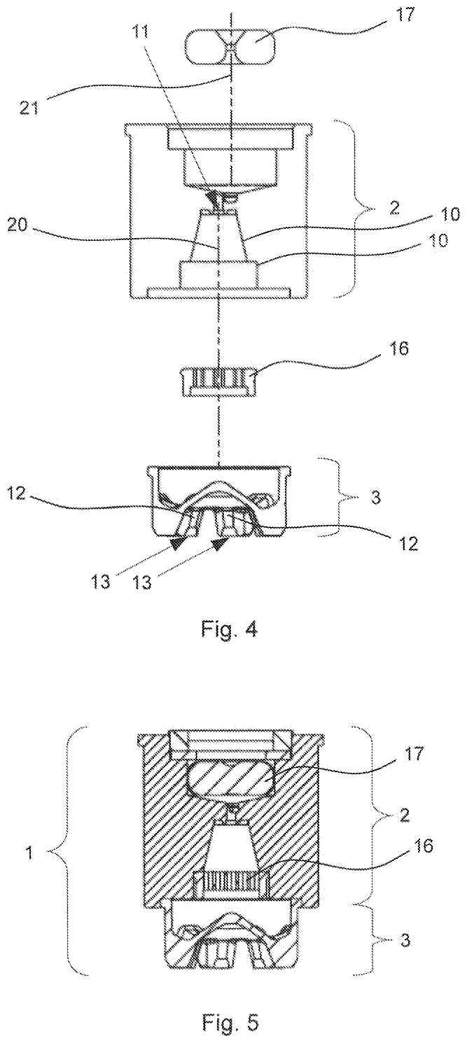

FIG. 4 schematically shows components of a second embodiment of a jet shaper in side view;

FIG. 5 schematically shows the jet shaper of FIG. 4 in an assembled state;

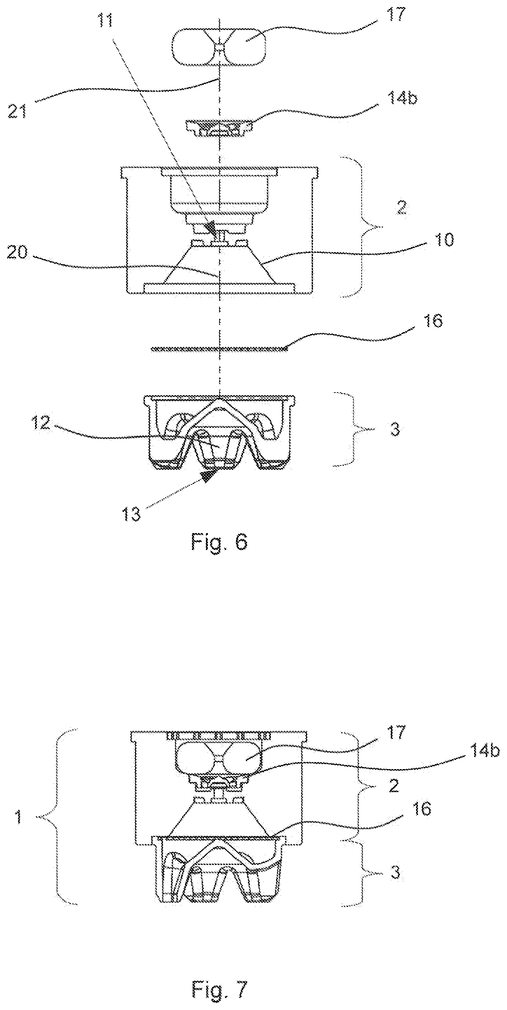

FIG. 6 schematically shows components of a third embodiment of a jet shaper in side view;

FIG. 7 schematically shows the jet shaper of FIG. 6 in an assembled state;

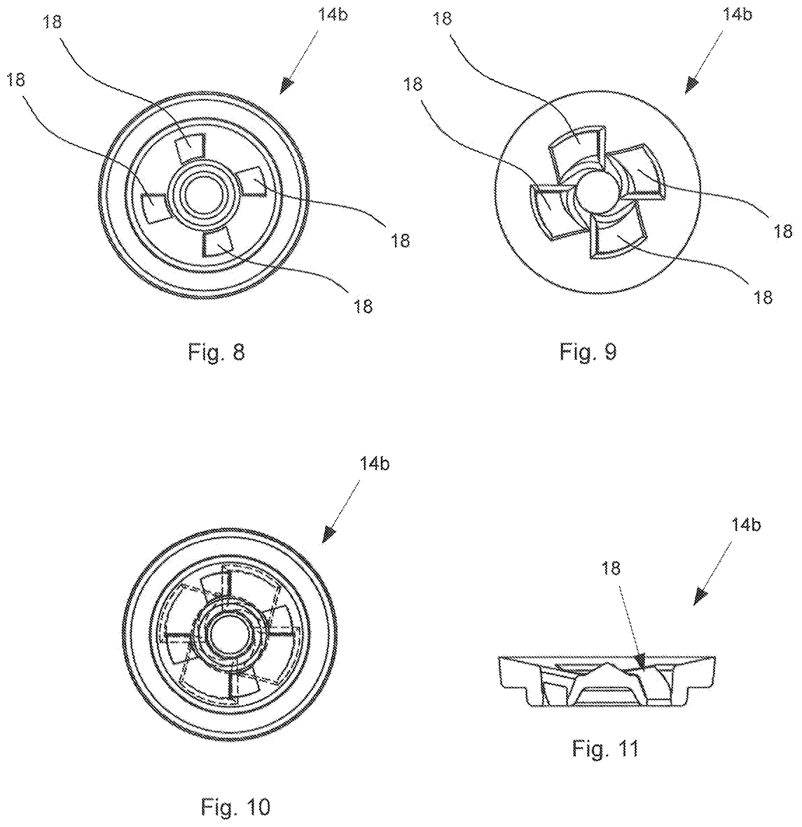

FIG. 8 schematically shows a guiding element unit of the jet shaper of FIG. 7 in bottom view;

FIG. 9 schematically shows the guiding element unit of FIG. 8 in top view;

FIG. 10 schematically shows the guiding element unit of FIG. 8 in bottom view with elements from the top view as interrupted lines;

FIG. 11 schematically shows a cut through the guiding element unit of FIG. 8 in side view;

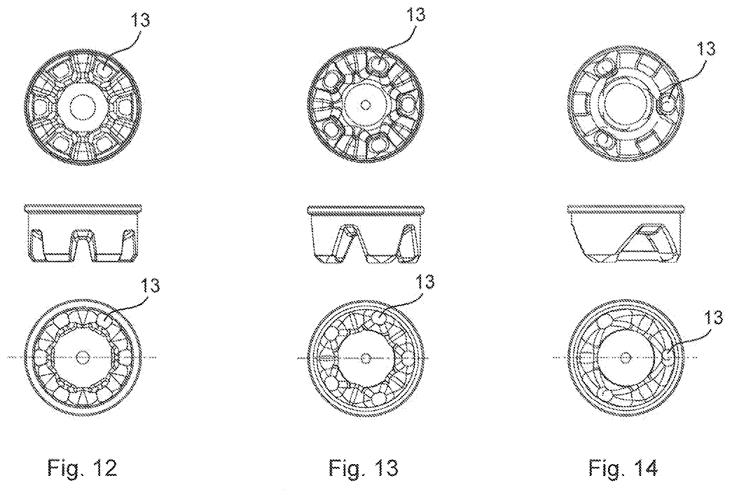

FIG. 12 schematically shows a jet distributor for six subjets;

FIG. 13 schematically shows a jet distributor for five subjets;

FIG. 14 schematically shows a jet distributor for three subjets

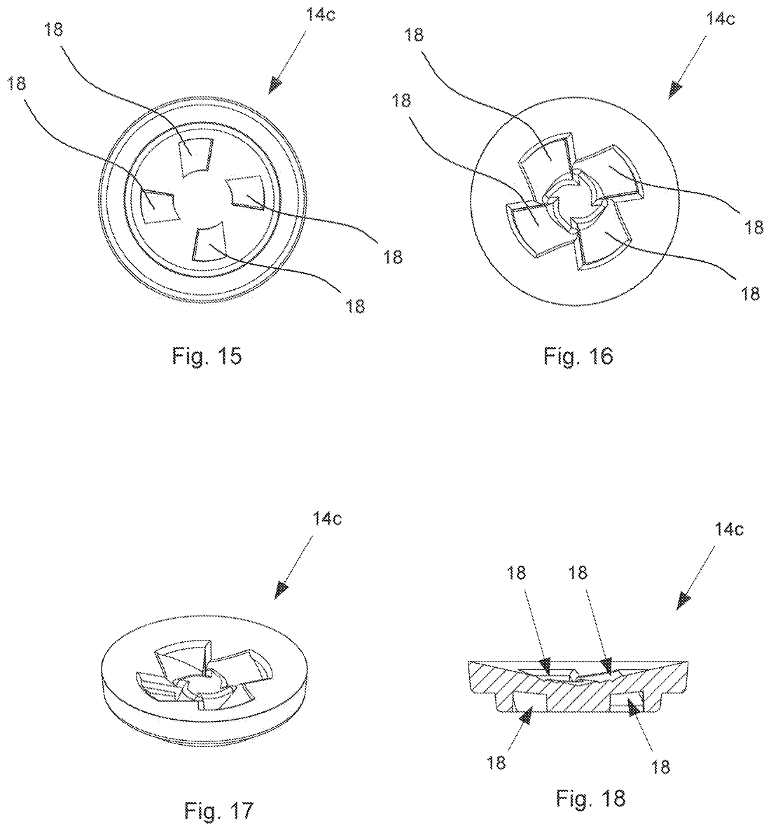

FIG. 15 schematically shows a second variant of a guiding element unit in bottom view;

FIG. 16 schematically shows the second guiding element unit variant in top view;

FIG. 17 schematically shows the second guiding element unit variant in perspective view;

FIG. 18 schematically shows a cut through the second guiding element unit variant in side view;

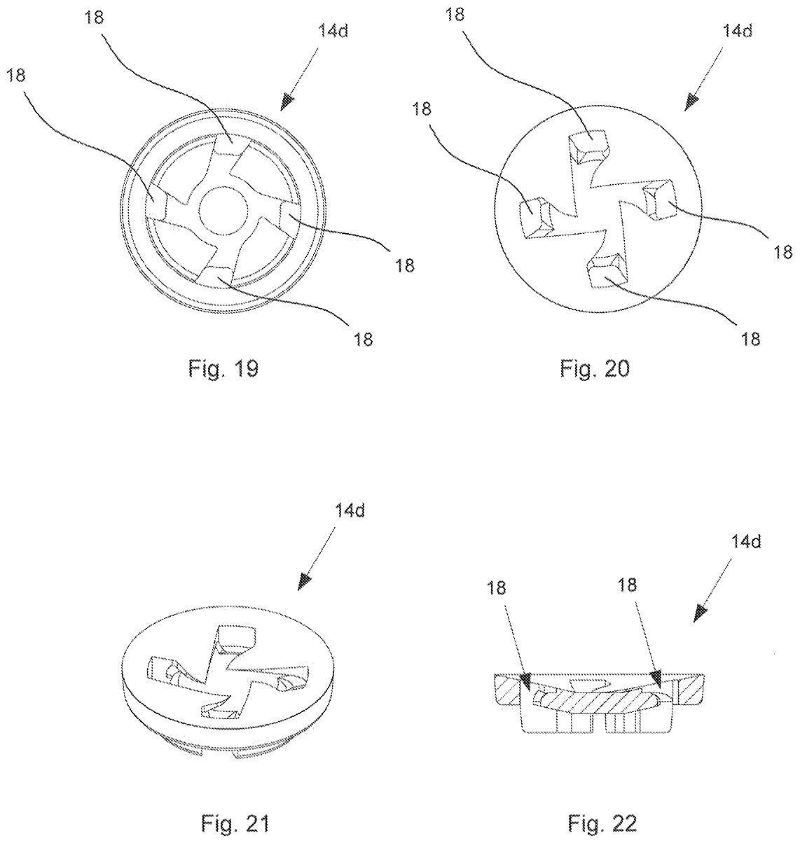

FIG. 19 schematically shows a third variant of a guiding element unit in bottom view;

FIG. 20 schematically shows the third guiding element unit variant in top view;

FIG. 21 schematically shows the third guiding element unit variant in perspective view;

FIG. 22 schematically shows a cut through the third guiding element unit variant in side view;

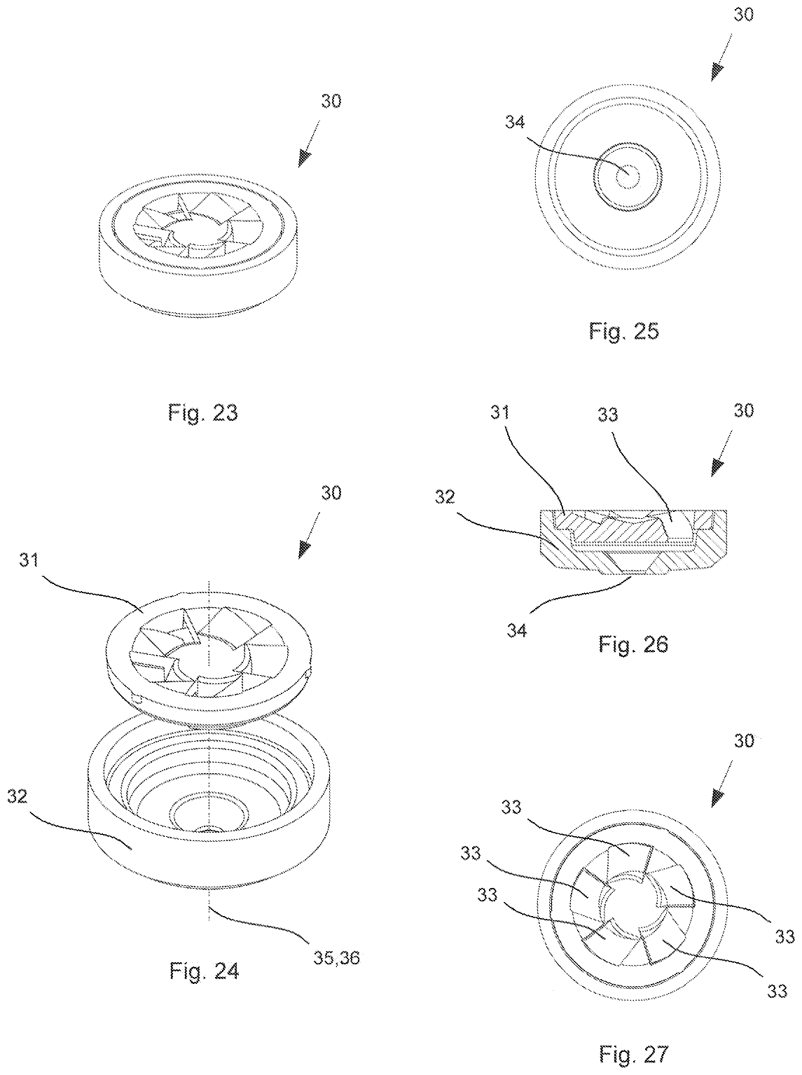

FIG. 23 schematically shows a spray shaper according to the second aspect of the invention in perspective view;

FIG. 24 schematically shows the spray shaper of FIG. 23 in exploded perspective view;

FIG. 25 schematically shows the spray shaper of FIG. 23 in bottom view;

FIG. 26 schematically shows a cut through the spray shaper of FIG. 23 in side view;

FIG. 27 schematically shows the spray shaper of FIG. 23 in top view.

In principle, identical parts are provided with the same reference symbols in the figures.

FIG. 1 shows a principle sketch of a cut through one example of an embodiment of a jet shaper 1 in side view. A direction of gravitation g runs from a top of FIG. 1 (i.e. a top edge of the drawing plane of FIG. 1) to a bottom of FIG. 1 (i.e. a bottom edge of the drawing plane of FIG. 1). The jet shaper 1 comprises a spray former 2, arranged on top of the jet shaper 1 and a spray distributor 3, arranged at the bottom of the jet shaper 1. A liquid 6 enters the jet shaper 1 in a liquid entry direction 22 which is parallel to the direction of gravity g.

The liquid 6 enters the spray former 2 and a guiding element 14a arranged in the spray former 2. The guiding element 14a generates a rotational movement of the liquid 6 around a swirling axis 21. Due to the rotational movement of the liquid 6, the liquid 6 is dispersed into droplets of a spray at a spray former outlet 11. The droplets of spray span up a spray cone 5 with an opening angle α and a cone axis 20. The cone axis 20 is in this embodiment coincident with the swirling axis 21. The spray cone 5 is free of contact with a flight chamber 10 which comprises the spray cone 5. An air inlet 15 provides air to the flight chamber 10. The droplets in the spray cone 5 follow a straight flight path from the spray former outlet through the flight chamber 10 towards the spray distributor 3.

In the spray distributor 3, spray distributor ducts 12 in the shape of a narrowing cone deflect and collect the droplet from the spray cone 5 into subjets 4. The subjets 4 leave the spray distributor 3 through subjet duct exits 13 in a subjet exit direction 23. The subjet exit direction 23 is parallel to the liquid entry direction 22.

FIG. 2 schematically shows some components of a first embodiment of a jet shaper 1 in side view. And FIG. 3 schematically shows the same embodiment of the jet shaper 1 like in FIG. 2 in an assembled state with all components. This first embodiment of the jet shaper 1 comprises a flow limiter 17 arranged in a top region of the spray former 2. The flow limiter 17 on one hand limits the flow and keeps the flow of the liquid 6 entering the spray former 2 constant. On the other hand, the flow limiter 17 also keeps a pressure of the liquid 6 on the jet shaper 1 constant a 1 bar or below, i.e. the liquid 6 has a pressure of 1 bar or below before it enters the spray former 2. In this first embodiment, the swirling axis 21 is offset in relation to the cone axis 20. The rotational movement of the liquid 6 is therefore eccentric with regard to the cone axis 20.

FIG. 4 schematically shows in an analogue manner some components of a second embodiment of a jet shaper 1 in side view. And FIG. 5 shows the same embodiment of the jet shaper 1 like in FIG. 4 in an assembled state with all components. The second embodiment in FIGS. 4 and 5 features a spray distributor 3 with a shape different from a shape of the spray distributor 3 of the first embodiment in FIGS. 2 and 3. But both the first and the second embodiment feature a swirling axis 21 which is arranged with an offset from the cone axis 20, and both embodiments feature a flow limiter 17 in a top region of the spray former 2. But the second embodiment of the jet shaper 1 in FIGS. 4 and 5 comprises furthermore a droplet size limiter 16. The droplet size limiter 16 is arranged at a bottom end of the spray former 2 and at a bottom end of the spray cone 5, just on top of the spray distributor 3. The droplet size limiter 16 allows droplets small enough to pass and reduces a size of droplets too large while essentially keeping the direction of flight of the droplets.

FIG. 6 schematically shows some components of a third embodiment of the jet shaper 1 in side view. And FIG. 7 schematically shows the same third embodiment of the jet shaper 1 of FIG. 6 in an assembled state. In the third embodiment, the cone axis 20 is coincident with the swirling axis 21. The third embodiment comprises a flow limiter 17 as well as a droplet size limiter 16 in form of a mesh. Furthermore, the third embodiment of the jet shaper 1 comprises a guiding element unit 14b which is detachable from the spray former 2 and which features liquid passages. The liquid passages feature a shape of small tubes arranged helicoidally around the swirling axis 21. All liquid 6 passing the jet shaper 1 passes the liquid passages and exits the liquid passages with a rotational movement induced by the liquid passages.

FIG. 8 schematically shows a guiding element unit 14b of the jet shaper of FIG. 7 in bottom view. This guiding element unit 14b features liquid passages 18. FIGS. 9 and 11 show the same guiding element unit 14b of FIG. 8 in top view respectively as a cut in side view. FIG. 10 on the other hand schematically shows the same guiding element unit 14b of FIG. 8 in bottom view with elements from the top view as interrupted lines for better illustration at the relative position of the openings of the liquid passages 18. The four liquid passages 18 feature a cross section in form of a annular sector (a sector of a two-dimensional ring) or in other words in form of a trapezoid with two curved sides (like an area on a dartboard besides the bulls eye).

The cross section of the four liquid passages 18 keep their shape while getting smaller along a flow direction of the fluid. Moreover, the liquid passages 18 extend with a component along the swirling axis 21 and a component around the swirling axis 21, resulting in a helicoidal opening around the swirling axis 21.

In other words, the guiding element unit 14b features four individual guiding elements which here are shaped to form the four liquid passages 18. This means that the number m of guiding elements in the guiding element unit 14b is equal to four.

FIG. 12 schematically shows a spray distributor 3 for six subjets 4, FIG. 13 schematically shows a spray distributor 3 for five subjets 4, and FIG. 14 schematically shows a spray distributor 3 for three subjets 4. Each of the FIGS. 12, 13 and 14 shows on top of the figure a figure of the spray distributor 3 in top view, below the top view then a side view and at the lower end of the figure a bottom view. The subjets 4 are exiting the subjet duct exits 13. For a better overview, only one spray distributor exit 13 per spray distributor 3 is referenced by a reference sign. All distributor duct exits 13 in the FIGS. 12, 13 and 14 are arranged in a circular line in an equidistant distribution along the circular line.

FIGS. 15 to 18 show a second variant 14c of a guiding element unit. A third variant 14d of a guiding element unit is shown in FIGS. 19 to 22.

FIG. 15 schematically shows the second variant 14c of a guiding element unit in bottom view, FIG. 16 in top view. FIG. 17 schematically shows the second guiding element unit variant 14c in perspective view, and FIG. 18 schematically shows a cut through the second guiding element unit variant 14c in side view. As seen in FIG. 18, the height of the guiding element unit 14c is small compared to its width. The height of the spray former part from the first point of the highest guiding element (i.e. the beginning of the liquid passages 18) down to the end of the guiding element unit 14c is 2 millimeters. In the assembled jet shaper 1, the height of the spray former part from the first point of the highest guiding element (i.e. the beginning of the liquid passages 18) down to the end of the spray former outlet results in 3.8 millimeters.

FIG. 19 schematically shows the third variant 14d of a guiding element unit in bottom view, and FIG. 20 in top view. FIG. 21 schematically shows the third guiding element unit variant 14d in perspective view, and FIG. 22 schematically shows a cut through the third guiding element unit variant 14d in side view. The second and third guiding element unit variants 14c, 14d both are of the same height, and both are arranged to feature a height of the spray former part from the first point of the highest guiding element (i.e. the beginning of the liquid passages 18) down to the end of the spray former outlet of 3.8 millimeters, once assembled in the jet shaper 1.

The second and third guiding element unit variants 14c, 14d both feature four individual guiding elements which are shaped to form the four liquid passages 18. This means that the number m of guiding elements in the second and third guiding element unit variants 14c, 14d is equal to four.

FIG. 23 schematically shows a spray shaper 30 according to the second aspect of the invention in perspective view, and FIG. 24 shows the same but in exploded perspective view. The spray shaper 30 comprises a spray shaper body which comprises two separate parts: a guiding element unit 31 and an outlet unit 32. In FIG. 24, the concentric and symmetric shape of the spray shaper 30 (and therefore also its components: the guiding element unit 31 and an outlet unit 32) around the swirling axis of the spray shaper 35 is shown. In the variant of the spray shaper shown in the FIGS. 23 to 27, the swirling axis 35 of the spray shaper 30 is not only parallel to the cone axis of the spray cone 36, the even are congruent.

FIG. 25 schematically shows the spray shaper of FIG. 23 in bottom view, FIG. 26 side view and FIG. 27 in top view. The guiding element unit 31 comprises five guiding elements 33 in symmetric arrangement around the swirling axis 35. The outlet unit 32 features the circular spray shaper outlet 34, arranged concentrically to the swirling axis 35. The inclination angle of the rotational movement of the liquid relative to a plane perpendicular to the swirling axis 35 of the spray shaper 30 is 20 degrees. The height of the spray shaper 30 is 3.8 millimeters and is equal to the height of the highest part of a guiding element 33 down to the most distant part of the spray shaper outlet 34. In other words: in orthogonal projection on the swirling axis 35 of the spray shaper 30, the most distant point of the least one guiding element 33 is 3.8 millimeters away from the most distant point of the spray shaper outlet 34.

While the invention has been described in present embodiments, it is distinctly understood that the invention is not limited thereto, but may be otherwise variously embodied and practised within the scope of the claims.

1. A jet shaper for shaping from a liquid a jet consisting of multiple subjects of the liquid, the jet shaper comprising a spray former and a spray distributor, wherein the spray former is arranged to generate from the liquid a spray of the liquid in a shape of a spray cone under ambient condition, and wherein the spray distributor is arranged to shape from the spray of the liquid the jet of the liquid, the jet of the liquid consisting of multiple subjets of the liquid being free of mutual overlap, wherein the spray former comprises a spray former outlet and a flight chamber, the spray former outlet being arranged as an exit point for the spray being generated, and the flight chamber being arranged to allow droplets of the spray to follow a flight path from the spray former outlet in an essentially straight line towards the spray distributor.

2. The jet shaper according to claim 1, wherein the spray former comprises at least one guiding element for the liquid inducing a rotational movement of the liquid around one swirling axis of the spray former, the rotational movement generating a spray wherein a cone axis of the spray cone is parallel to the swirling axis of the spray former.

3. The jet shaper according to claim 2, wherein the number n of subjets of the liquid is equal or an integer multiple of the number m of guiding elements for the liquid, such that n=x*m where x is an integer number greater or equal to 1.

4. The jet shaper according to claim 2, wherein the guiding element for the liquid comprises a liquid passage for inducing the rotational movement of the liquid passing through the liquid passage, the liquid passage being arranged in form of a circumferentially enclosed opening in the spray former, the opening extending with a component along the swirling axis as well as a component around the swirling axis.

5. The jet shaper according to claim 2, wherein the swirling axis of the spray former is coincident with the cone axis of the spray cone.

6. The jet shaper according to claim 2, wherein, in orthogonal projection on the swirling axis of the spray former, the most distant point of the least one guiding element is maximally 5 millimeters away from the spray former outlet.

7. The jet shaper according to claim 5, wherein the spray former outlet features a diameter which lies in a range beginning with 0.3 millimeters and ending with 5 millimeters.

8. The jet shaper according to claim 1, wherein the number of subjets lies in a range beginning with 2 subjets and ending with 20 subjets.

9. The jet shaper according to claim 1, wherein subjets exit the spray distributor at subjet duct exits that are all arranged in only one linear line or in only one substantially round line on the spray distributor.

10. The jet shaper according to claim 1, wherein the spray former comprises an air inlet.

11. The jet shaper according to claim 1, wherein the jet shaper is arranged for a liquid flow of the liquid through the jet shaper equal to or less than 2 liters per minute.

12. The jet shaper according to claim 1, wherein the jet shaper comprises a droplet size limiter positioned downstream of the spray former, the droplet size limiter being arranged to allow passage of the spray droplets free of a backflow.

13. The jet shaper according to claim 1, wherein the jet shaper is arranged for a liquid entry direction of the liquid entering the jet shaper being substantially parallel to a subjet exit direction.

14. An installation comprising a jet shaper according to claim 1, wherein the jet shaper is mounted in the installation and arranged for the subjets exiting the jet shaper to follow a trajectory through air essentially along the direction of gravity.

15. A method for shaping from a liquid a jet of the liquid comprising
a) generating a spray cone of the liquid from the liquid, the liquid droplets inside the spray cone following an essentially straight flight path in the spray cone, and
b) shaping the jet of the liquid from the spray cone of the liquid at an end of the spray cone, the jet of the liquid consisting of multiple subjets of the liquid being free of mutual overlap.
